(19) United States
(12) Patent Application Publication
(10) Pub. No.: US 2023/0108108 A1
(43) Pub. Date: Apr. 6, 2023

(54) SUSCEPTOR FOR AEROSOL GENERATION APPARATUS, AND AEROSOL GENERATION APPARATUS

(71) Applicant: SHENZHEN FIRST UNION TECHNOLOGY CO., LTD., Shenzhen , Guangdong (CN)

(72) Inventors: ZUQIANG QI, Shenzhen City, Guangdong Province (CN); BAOLING LEI, Shenzhen City, Guangdong Province (CN); JIAN WU, Shenzhen City, Guangdong Province (CN); JIAMAO LUO, Shenzhen City, Guangdong Province (CN); ZHONGLI XU, Shenzhen City, Guangdong Province (CN); YONGHAI LI, Shenzhen City, Guangdong Province (CN)

(21) Appl. No.: 17/914,353

(22) PCT Filed: Mar. 25, 2021
(86) PCT No.: PCT/CN2021/083055

§ 371 Date: Sep. 25, 2022

(30) Foreign Application Priority Data
Mar. 25, 2020 (CN) 202010220547.8

(51) Int. Cl. A24F 40/465; A24F 40/20; A24F 40/46; H05B 6/10

(52) U.S. Cl. CPC A24F 40/465; A24F 40/20; A24F 40/46; H05B 6/105; C22C 21/12

(57) ABSTRACT

Disclosed are a susceptor for an aerosol generation apparatus, and the aerosol generation apparatus. The susceptor includes: a metal body, which may be penetrated by a varying magnetic field to generate heat; and a protective layer, formed on the metal body, the protective layer containing a quasicrystal alloy material to reduce adhesion or deposition of organic matter from a smokable material on the surface of the susceptor. When in use, water vapor, aerosol condensation oil, and the like from the smokable material cannot spread on the surface of the quasicrystal alloy material, and can be maintained in a substantially spherical shape and can be easily separated from the susceptor. Meanwhile, solid-phase organic matter such as tobacco slag and carbon deposition falling on the susceptor is difficult to be stubbornly bound to the protective layer, without forming stubborn adhesion or deposition.

### CROSS-REFERENCE TO RELATED APPLICATIONS

The present application claims priority to Chinese Patent Application No. 202010220547.8, filed on Mar. 25, 2020 and entitled “SUSCEPTOR FOR AEROSOL GENERATION APPARATUS, AND AEROSOL GENERATION APPARATUS”, which is incorporated herein by reference in its entirety.

### TECHNICAL FIELD

Embodiments of the present application relate to the technical field of electromagnetic induction type heat-not-burn smoking sets, and in particular relate to a susceptor for an aerosol generation apparatus and the aerosol generation apparatus.

### BACKGROUND

Smoking articles (e.g., cigarettes, cigars, etc.) burn tobacco during use to produce tobacco smoke. Attempts have been made to replace these articles that burn tobacco by making products that release compounds without burning.

Examples of such products are heating apparatuses, which release compounds by heating, rather than burning materials. For example, the material may be tobacco or other non-tobacco products, and the non-tobacco products may or may not contain nicotine. As one example, an induction heater having suitable magnetic permeability properties is employed to heat under the induction of an alternating magnetic field, thereby heating a tobacco product to release compounds to form an aerosol for smoking. A known induction heater is generally prepared from stainless iron, iron-nickel alloy and other materials which contain iron, nickel and the like with suitable magnetic conductivity, has relatively active surface properties, and is relatively easy to adhere to slag of tobacco products and organic matter generated by condensation of aerosol in use. In a preferred embodiment, an anti-tobacco dirt and anti-corrosion protective coating such as glass glaze and inorganic ceramic is coated on the surface. Known protective coatings are insufficient in strength, and insufficient in the effect of preventing tobacco dirt and preventing the adhesion of the tobacco slag and condensate.

### SUMMARY

Embodiments of the present application aim to provide a susceptor for an aerosol generation apparatus and the aerosol generation apparatus, so as to solve the problem that solid-phase organic matter such as tobacco slag and carbon deposition falling on the susceptor forms stubborn adhesion or deposition on susceptor components in the prior art.

An embodiment of the present application provides a susceptor for an aerosol generation apparatus, the aerosol generation apparatus is configured to heat a smokable material to generate an aerosol, the susceptor including:
a metal body, which is penetrated by a varying magnetic field to generate heat; and
a protective layer, formed on the metal body, the protective layer containing a quasicrystal alloy material to reduce adhesion or deposition of organic matter from the smokable material on the surface of the susceptor.

In a more preferred embodiment, the thickness of the protective layer is between 100 µm and 500 µm.

In a more preferred embodiment, the quasicrystal alloy material is a quasicrystal alloy containing aluminum.

In a more preferred embodiment, the quasicrystal alloy material is an Al—Cu—Fe quasicrystal alloy.

In a more preferred embodiment, the quasicrystal alloy material contains at least one of Al—Fe, Al—Cu—Fe, Al—Cu—Fe—Si, Al—Cu—Fe—Cr, Al—Cu—Fe—Cr—Si, Al—Cu—Co, Al—Cu—Co—Si, Al—Cu—Cr, Al—Co—Ni, Al—Mn, Al—Pd—Mn, Ga—Mn, Bi—Mn, Mg—Zn—Nd or Ti—Zr—Ni quasicrystal alloys.

In a more preferred embodiment, the contact angle of the surface of the protective layer to water is greater than 120 degrees.

In a more preferred embodiment, the contact angle of the surface of the protective layer to aerosol condensation oil is greater than 105 degrees.

In a more preferred embodiment, the protective layer has the microhardness of 5.2-7.0 GPa.

Another embodiment of the present application further provides an aerosol generation apparatus, for heating a smokable material to generate an aerosol, including:
a cavity, configured to receive at least a part of the smokable material;
a magnetic field generator, configured to generate an alternating magnetic field; and
an induction heater, configured to be penetrated by the alternating magnetic field to generate heat, to heat the smokable material received within the cavity;
where the induction heater includes a susceptor applied to the aerosol generation apparatus.

Yet another embodiment of the present application further provides an aerosol generation apparatus, for heating a smokable material to generate an aerosol, including:
a cavity, configured to receive at least a part of the smokable material; and
a resistive heater, configured as a pin or blade shape extending along the axial direction of the cavity, and inserted into the smokable material to heat the same when the smokable material is received within the cavity,
where the resistive heater is provided with a surface protective layer, the surface protective layer containing a quasicrystal alloy material to reduce adhesion or deposition of organic matter from the smokable material on the surface of the susceptor.

When the above susceptor is in use, water vapor, aerosol condensation oil, and the like from the smokable material cannot spread on the surface of the quasicrystal alloy material, and thus can be maintained in a substantially spherical shape and can be easily separated from the susceptor. Meanwhile, solid-phase organic matter such as tobacco slag and carbon deposition falling on the susceptor is difficult to be stubbornly bound to the protective layer, without forming stubborn adhesion or deposition on components of the susceptor.

### BRIEF DESCRIPTION OF DRAWINGS

One or more embodiments are illustrated by pictures in the corresponding accompanying drawings, which are not intended to limit the embodiments, in which elements having the same reference numerals represent similar elements, and the figures of the accompanying drawings are not intended to constitute a scale limitation unless specifically stated otherwise.

FIG. 1 is a schematic structural diagram of an aerosol generation apparatus according to an embodiment;

FIG. 2 is a schematic structural diagram of a susceptor according to another embodiment;

FIG. 3 is a schematic structural diagram of a susceptor having a protective layer according to an embodiment;

FIG. 4 is a microtopography diagram of the surface of a protective layer according to an embodiment;

FIG. 5 is a microtopography diagram of a cross section of a susceptor having a protective layer according to an embodiment;

FIG. 6 is an XRD diffractometer diagram of a protective layer at a site according to an embodiment;

FIG. 7 is test results of a surface friction factor of a protective layer according to an embodiment;

FIG. 8 is test results of a surface friction factor of a metal body according to an embodiment; and

FIG. 9 is test results of a static contact angle of the surface of a protective layer to tobacco tar according to an embodiment.

### DETAILED DESCRIPTION

To facilitate the understanding of the present application, the present application will be described in more detail below with reference to the accompanying drawings and detailed description.

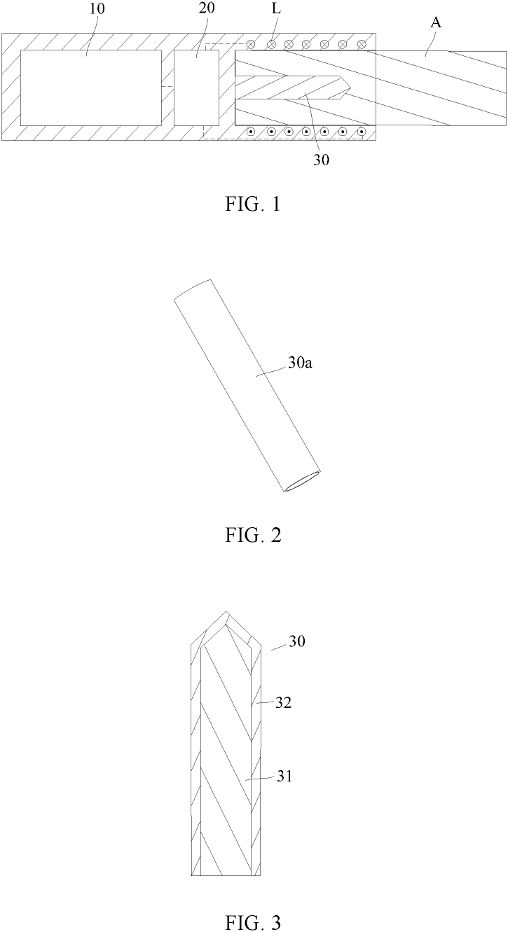

The present application provides an inductively heated aerosol generation apparatus, and the configuration of which in an embodiment is shown in FIG. 1, including:
a cavity, within which a smokable material A such as a cigarette is removably received;
an inductance coil L, used as a magnetic field generator and configured to generate an alternating magnetic field under alternating current;
a susceptor 30, at least a part of which extends within the cavity, and configured to be inductively coupled to the induction coil L, and penetrated by the alternating magnetic field to generate heat, so as to heat the smokable material A to volatilize at least one component of the smokable material A to form an aerosol for smoking;
a battery cell 10, which is a rechargeable direct-current battery cell and can provide direct voltage and direct current; and
a circuit 20, electrically connected to the rechargeable battery cell 10, and configured to convert the direct current output by the battery cell 10 into the alternating current with a suitable frequency, and then supply the same to the inductance coil L.

Depending on configuration of the product in use, the susceptor 30 is in a blade or pin shape that is inserted into the smokable material A for heating. In a preferred embodiment, the susceptor has the length of about 15 millimeters, the width of about 6 millimeters and the thickness of about 1 millimeter.

In another preferred embodiment, referring to FIG. 2, the susceptor 30a may also be configured as a cylindrical shape. When the susceptor is in use, the interior space thereof is configured to receive the smokable material A and generate aerosol by means of heating the periphery of the smokable material A for smoking.

In an embodiment of the present application, the structure of the susceptor 30 can be seen in FIG. 3, including:
a metal body 31, configured to be penetrated by a varying magnetic field to generate heat, so as to heat a smokable material, where in a preferred embodiment, the metal body 31 is made from stainless iron, nickel steel, permalloy and other alloy materials containing iron, nickel and the like with excellent magnetic conductivity; and
a protective layer 32, formed on the surface of the metal body 31 and having low surface free energy. In some embodiments, the protective layer 32 is a protective layer 32 of a quasicrystal alloy material, the quasicrystal alloy being a solid-phase material made of metal and between crystalline and amorphous.

Specifically, in the field of material science, the structure of the crystal material has long-range orderliness, and structural units are periodically arranged, such that stronger symmetry is shown. When corresponding points of any two unit cells rotate by 2π/n (n = 1, 2, 3, 4, 5, 6) or integral multiples thereof around a rotation axis passing through crystal lattice points, a lattice coinciding with itself can always be found. This property is called crystal orientation symmetry. According to basic laws of crystallography, the crystal orientation symmetry is limited by periodicity, and there are only a few fixed ones. That is, the orientation symmetry can only be achieved while n=1, 2, 3, 4, 6, and cannot be achieved while n=5 or n>6. Certainly, amorphous materials have long-range disorderliness without any symmetry.

Quasicrystals are solids between crystalline and amorphous, and have quasi-periodic long-range translational symmetry (not having translational symmetry that a crystal should have) and orientation symmetry while n ≥ 5, enabling quasicrystal alloys to have relatively low surface free energy, which is specifically related to the following three factors:

(1) a surface electron structure: pseudo-gaps exist at the Fermi energy level and are remained all the way to the outer surface; (2) a thermodynamic factor: the surface of a quasicrystal film or coating has certain roughness of a micro-nano structure, which is beneficial to reducing surface energy. (3) hysteresis: the curved surfaces of quasicrystal particles increase a critical wetting angle, which restrains the movement of liquid trying to wet the surface.

By using the susceptor 30 provided with the above quasicrystal protective layer 32, water vapor, aerosol condensation oil and the like from the smokable material A cannot spread on the surface of the quasicrystal protective layer 32 when in use, and thus can be maintained in a substantially spherical shape and can be easily separated from the susceptor 30. Meanwhile, solid-phase organic matter such as tobacco slag and carbon deposition falling the susceptor 30 is difficult to be stubbornly bound to the protective layer 32, and is taken away from the surface of the susceptor 30 along with a cigarette during the process of pulling out the smokable material A such as the cigarette after smoking, without forming stubborn adhesion or deposition on components of the susceptor 30.

The quasicrystal alloy protective layer 32, which has superplasticity at high temperature, is employed such that thermal stress caused by different thermal expansion coefficients of the susceptor 30 can be relieved. In addition, the quasicrystal material has excellent corrosion resistance and oxidation resistance, and thus the susceptor 30 is prevented from being oxidized, rusted and the like.

Furthermore, in an optional embodiment, the quasicrystal alloy protective layer 32 contains at least one of a series of quasicrystal alloy materials such as Al—Fe, Al—Cu—Fe, Al—Cu—Fe—Si, Al—Cu—Fe—Cr, Al—Cu—Fe—Cr—Si, Al—Cu—Co, Al—Cu—Co—Si, Al—Cu—Cr, Al—Co—Ni, Al—Mn, Al—Pd—Mn, Ga—Mn, Bi—Mn, Mg—Zn—Nd or Ti—Zr—Ni quasicrystal alloys. In a preferred embodiment, considering that the Al—Cu—Fe system is relatively easy to obtain a stable quasicrystal, Al—Cu—Fe is employed as the material of a thin film coating in the preferred embodiment.

In a more preferred embodiment, the thickness of the quasicrystal alloy protective layer 32 is configured to be about 100-500 µm, and prevented from being higher than 500 µm as much as possible, to eliminate the disadvantage of relatively low thermal conductivity of the quasicrystal alloy. In a preferred embodiment, the quasicrystal alloy protective layer 32 is made of an alloy containing Al, such that the heat conduction efficiency can be relatively improved.

In a more preferred embodiment, the static contact angle of the employed quasicrystal alloy protective layer 32 to water is greater than 120 degrees, and the contact angle of the same to aerosol condensation oil is greater than 105 degrees.

Furthermore, in order to facilitate the verification of advancement in strength, anti-adhesion, and resistance of the susceptor 30 employing the above quasicrystal alloy protective layer 32, the prepared susceptor 30 will be exemplified and results will be described below through specific embodiments.

### Embodiment 1

Embodiment 1 of the present application is described by taking the preparation of a sheet-shaped susceptor 30 having an Al—Cu—Fe quasicrystal alloy protective layer 32 as an example.

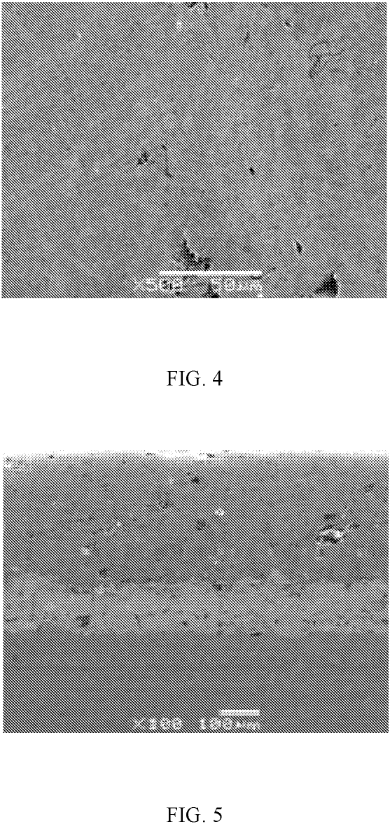

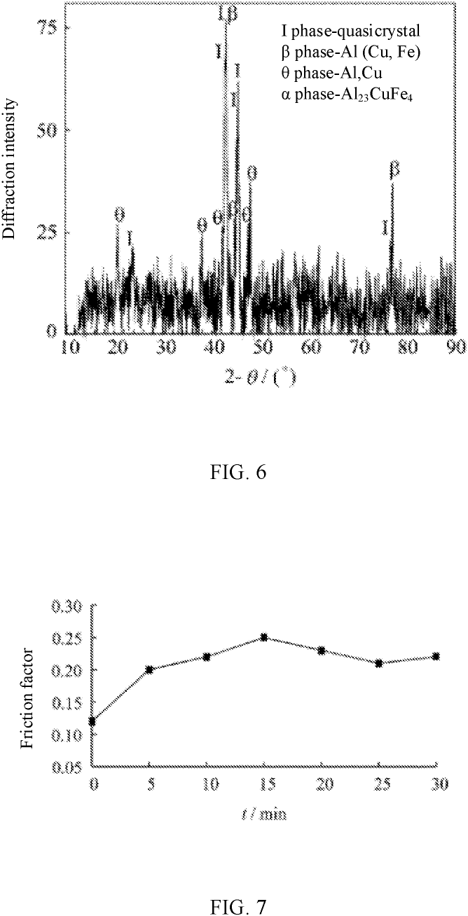

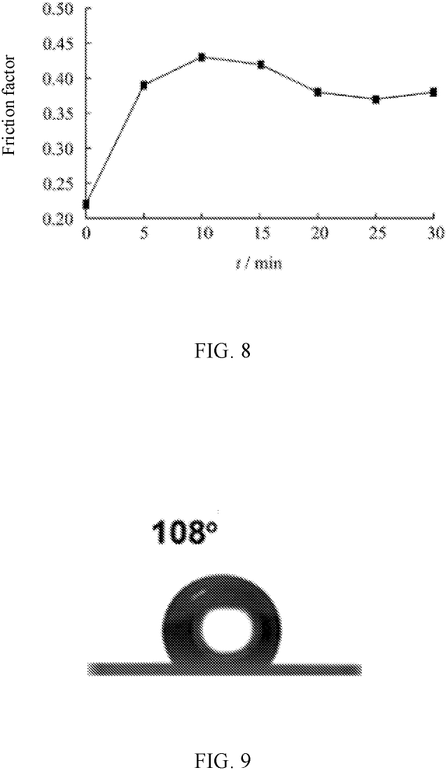

S10. Material pretreatment, specifically including:
S11. Obtain a metal body 31 of a permalloy material complying with the J185 standard and having the shape as shown in FIG. 3, and clean and dry the surface of the metal body;
S12. Perform sand blasting on the surface of a heating needle of the metal body 31 with 180-mesh to 400-mesh white corundum sand, where on the basis of requirements for improving the bonding strength of the Al—Cu—Fe quasicrystal alloy protective layer 32 and the metal body 31, sanding can be performed according to the final surface roughness of 3-5 microns of the metal body 31; and
S13. Perform ultrasonic cleaning on the metal body 31 with acetone to clean the surface.
S20. Form the Al—Cu—Fe quasicrystal alloy protective layer 32: obtain aluminum powder, copper powder and iron powder with the granularity of 15-100 µm according to the proportion of Al₆₅Cu₂₀Fe₁₅ alloy to serve as thermal spraying materials, and spray the surface of the metal body 31 by employing supersonic flame spraying equipment. During spraying, liquid propane is employed as fuel of the supersonic flame spraying equipment, the liquid propane is gasified via a vaporizer and then mixed with compressed oxygen for combustion in a combustion chamber of a spray gun, and then accelerated via a Laval nozzle to obtain a supersonic flame beam. Therefore, Al₆₅Cu₂₀Fe₁₅ quasicrystal alloy powder is injected into the combustion chamber of the spray gun by an axial powder injector via an air beam, the alloy powder is heated and accelerated under the action of the supersonic flame beam, and a high-speed alloy powder beam impacts the surface of the metal body 31 to form a coating, thereby forming the susceptor 30 having the quasicrystal alloy protective layer 32. During the spraying process, the metal body 31 keeps rotating continuously such that the thickness of the coating is uniform.
S30. Put the susceptor 30 having the quasicrystal alloy protective layer 32 that has treated in step S20 in a vacuum furnace for heat treatment, and during the heat treatment process, control the pressure in the furnace to be within 10³ Pa (a proper amount of chlorine gas (50-300 sccm) can be introduced as protective gas), control the heat treatment temperature to be 700-900 DEG C and control the heat treatment time to be 1-5 hours, causing the quasicrystal phase of the quasicrystal alloy protective layer 32 to be more compact and stable.
S40. In order to verify the surface self-cleaning ability of the prepared Al₆₅Cu₂₀Fe₁₅ quasicrystal alloy protective layer 32, perform the following performance verification on the susceptor 30 having the protective layer 32:
S41. Microtopography detection: different multiples of microtopography detected by a scanning electron microscope being shown in FIG. 4 and FIG. 5, where FIG. 4 is a 500-time scanning electron micrograph of the surface of the quasicrystal alloy protective layer 32, and FIG. 5 is a 100-time scanning electron micrograph of the cross-section of the susceptor 30. It can be observed from FIG. 4 and FIG. 5 that although air holes exist in the surface of the quasicrystal coating, the powder with the compact overall morphology is fully melted, and the distribution of the air holes in the coating is relatively uniform.
S42. Carry out XRD diffractometer analysis on a selected point of the protective layer 32, where analyzed phase components are shown in FIG. 6, including a main phase quasicrystal I phase, a small amount of quasicrystal analogue phase β phase, a crystal phase θ phase, and a very small amount of crystalline phase α phase which is caused by the integration of raw materials, spraying process, subsequent processing and other processes.
S43. A comparative test of a surface friction factor.
S431. Measurement of the surface friction factor of the above susceptor 30: specifically use a CETR-UMT friction and wear testing machine to perform measurement for 30 min, take points every 5 min and recording the friction factor, and make a change curve of the friction factor and the friction time as shown in FIG. 7. From test results in FIG. 7, the friction factor is generally small at the beginning, then increases and stabilizes, accompanied by a small range of fluctuations, decreases within the range of 15-20 min, and finally starts to increase slightly until it is stable. This is due to the fact that the sample is not smooth at the beginning, actual contact area is small, and the adhesion therebetween is weak, resulting in the relatively small friction factor. After micro-bulges on the surface of the sample are abraded off, the actual contact area is increased, a friction heat effect is increased accordingly, friction vibration is intensified, and at the moment, the friction factor begins to increase and reaches the maximum value. After further friction, particles which are ground off during the friction process are gradually ground into fine particles, friction tracks become smooth and thus friction resistance is reduced, and the friction factor finally becomes stable after a slight decrease.
S432. In order to compare the improvement of the surface smoothness of the above susceptor 30 having the quasicrystal alloy protective layer 32 with that of the metal body 31 directly employing J185 permalloy, directly perform a surface friction factor test in the same way on the later one at the same time, the results of which are shown in FIG. 8. From the results of the comparative test of the friction factor shown in FIG. 8, the friction factor of the quasicrystal coating is about one time than the friction factor of the quasicrystal coating during the entire friction process, indicating that the quasicrystal alloy coating has a low friction factor.
S44. Further detect the hardness of the prepared Al₆₅Cu₂₀Fe₁₅ quasicrystal alloy protective layer 32, measure the microhardness Hv (5.2-7.0 GPa) of the protective layer 32 by a commonly used Micromet-6030 type microhardness tester, which is about 10 times higher than that of commonly used aluminum alloy (0.6-0.9 GPa).
S45. GB2423.17 standard 48 H salt spray test: prepare 5% salt water in a salt spray machine, then set the temperature in the salt spray machine to be 35 DEG C and start to spray, and continue for 48 hours, where if no corrosion or rust point exists on the surface of the susceptor 30 sample, the sample can reach tolerance standards of the salt spray test.
S46. Standard anti-fouling performance test: coat with an oily marking pen, place for 24 hours, and wipe with an alcohol cotton ball, the coating can be completely wiped off and the surface of sample is clean.
S47. Aerosol condensation oil adhesion prevention test: measure the contact angle of tobacco tar containing 0.5 wt% of nicotine added into PG/VG (glycerol/vegetable glycerol) on the surface of the susceptor 30 by using a contact angle measuring instrument JC-2000C1 (Shanghai Zhongchen Digital Technology Equipment Co., Ltd.). The test results are shown in FIG. 9, which can reach 108 degrees, and can be further improved if the preparation process is more precise and the material purity is further reduced.
S48. Tobacco slag adhesion prevention test: smoke a heat-not-burn cigarette (Phillips Morris-IQOS) by using the aerosol generation apparatus having the susceptor 30, and check the adhesion condition of the tobacco slag and aerosol condensation oil after use on the surface of the susceptor 30 after the smoking of every cigarette.

Results show that after the first to the twelfth cigarettes are smoked, small particle dust (the area is smaller than 1 mm ²) is dispersed on the surface of the susceptor 30 and gradually increased along with the increase of the number of the smoked cigarettes, but the particle size is smaller; meanwhile, tobacco shreds and condensation oil stains scattered to the surface of the susceptor 30 from the cigarettes are only slightly adhered thereto and can fall off by blowing and shaking, and thus no stubborn deposition or agglomeration is formed; and after the thirteenth cigarette is smoked, agglomerated clumps of tobacco slag and condensation oil that are significantly visible to naked eyes (the area of the clumps is greater than 4 mm²) begins to appear on the surface of the susceptor 30.

### Comparative Example 1

In the Comparative Example 1, commonly used standard SS430 stainless iron and J185 permalloy susceptors 30 are respectively subjected to three comparative performance tests:
S10. GB2423.17 standard 48 H salt spray test: prepare 5% salt water in a salt spray machine, then set the temperature in the salt spray machine to be 35 DEG C and start to spray, and continue for 48 hours.
In the results, light and visible rust spots are formed on the surface of the standard SS430 stainless iron material that has been subjected to the 48 H salt spray test, and the J185 permalloy material can pass the 48 H salt spray test.
S20. Surface waterproofing and aerosol condensation oil prevention test: after dripping a small amount of condensation oil on the surfaces of the standard SS430 stainless iron and J185 permalloy susceptors 30, check the state of oil drops, and measure the contact angles of the surfaces of the susceptors by using a contact angle measuring instrument JC-2000C1 (Shanghai Zhongchen Digital Technology Equipment Co., Ltd,). In the results, firstly, the small oil drops are in a basically flat state after being diffused, which indicates that the surface morphology of the SS430 stainless iron material and the surface morphology of the J85 permalloy are not enough to maintain surface tension of the drops to maintain the spherical shape thereof, it is tested that the contact angle of the SS430 stainless iron susceptor 30 is 58 degrees and the contact angle of the J185 permalloy susceptor 30 is about 65 degrees, and the water drops on the surfaces are in the spreading form that tends to collapse.
S30. Tobacco slag adhesion prevention test: results show that when the fifth or sixth cigarette is smoked, agglomerated clumps of tobacco slag and condensation oil that are significantly visible to naked eyes (the area of the clumps is greater than 4 mm²) begin to appear on the surfaces of the SS430 stainless iron and J85 permalloy susceptors 30, cannot fall off by blowing and shaking, and need to be wiped with an alcohol cotton ball.

It can be seen from the above that the susceptor having the quasicrystal alloy protective layer on the surface has the better effect of preventing adhesion of tobacco slag, condensation oil and the like after a heat-not-burn cigarette is heated, the hardness, corrosion resistance and the like of the standard SS430 stainless iron, J185 permalloy and other susceptors can be improved, and the service life and stability of the same are much better.

Alternatively, in a variant embodiment of the present application, the susceptor 30, which heats the smokable material A by means of electromagnetic induction, may also be configured to be a resistive heater in the shape of a pin or blade as shown in FIG. 3. The resistive heater has a protective layer made from the above quasicrystal alloy on the surface, and when the resistive heater is in use, adhesion and deposition of aerosol condensation oil, tobacco slag or the like from the smokable material A are inhibited by the low surface free energy property thereof.

Generally in an optional embodiment, the resistive heater typically includes a ceramic substrate, such as zirconia ceramic, and patterned conductive traces formed on the ceramic substrate by means of printing, depositing or the like, where the conductive traces are prepared from a resistive heating material, such that the smokable material A is heated by means of resistive heating when power is supplied.

Certainly, during forming of the quasicrystal alloy protective layer on the surface of the resistive heater, because the quasicrystal alloy has low electrical conductivity based on the crystal phase structure thereof, the quasicrystal alloy protective layer may be directly printed or deposited on the surface of the resistive heater in the embodiment. Alternatively, in a more preferable embodiment, insulation treatment can be firstly performed on the surface of the resistive heater, and then the quasicrystal alloy protective layer is formed.

It should be noted that the preferred embodiments of the present application are given in the description and the accompanying drawings of the present application, but are not limited to the embodiments described in the description, and furthermore, for those of ordinary skill in the art, improvements or transformations can be made according to the above description, and all these improvements and transformations should fall within the protection scope of the appended claims of the present application.

1. A susceptor for an aerosol generation apparatus, wherein the aerosol generation apparatus is configured to heat a smokable material to generate an aerosol, the susceptor comprising:
a metal body, which is penetrated by a varying magnetic field to generate heat; and
a protective layer, formed on the metal body, the protective layer containing a quasicrystal alloy material to reduce adhesion or deposition of organic matter from the smokable material on the surface of the susceptor.

2. The susceptor for an aerosol generation apparatus according to claim 1, wherein the thickness of the protective layer is between 100 µm and 500 µm.

3. The susceptor for an aerosol generation apparatus according to claim 1, wherein the quasicrystal alloy material is a quasicrystal alloy containing aluminum.

4. The susceptor for an aerosol generation apparatus according to claim 3, wherein the quasicrystal alloy material is an Al—Cu—Fe quasicrystal alloy.

5. The susceptor for an aerosol generation apparatus according to claim 1, wherein the quasicrystal alloy material comprises at least one of Al-Fe, Al—Cu—Fe, Al—Cu—Fe—Si, Al—Cu—Fe—Cr, Al—Cu—Fe—Cr—Si, Al—Cu—Co, Al—Cu—Co—Si, Al—Cu—Cr, Al—Co—Ni, Al—Mn, Al—Pd—Mn, Ga—Mn, Bi—Mn, Mg—Zn—Nd or Ti—Zr—Ni quasicrystal alloys.

6. The susceptor for an aerosol generation apparatus according to claim 1, wherein the contact angle of the surface of the protective layer to water is greater than 120 degrees.

7. The susceptor for an aerosol generation apparatus according to claim 1, wherein the contact angle of the surface of the protective layer to aerosol condensation oil is greater than 105 degrees.

8. The susceptor for an aerosol generation apparatus according to claim 1, wherein the protective layer has the microhardness of 5.2-7.0 GPa.

9. An aerosol generation apparatus, for heating a smokable material to generate an aerosol, comprising:
a cavity, configured to receive at least a part of the smokable material;
a magnetic field generator, configured to generate an alternating magnetic field; and
an induction heater, configured to be penetrated by the alternating magnetic field to generate heat, to heat the smokable material received within the cavity;
wherein the induction heater comprises the susceptor for an aerosol generation apparatus according to claim 1.

10. An aerosol generation apparatus, for heating a smokable material to generate an aerosol, comprising:
a cavity, configured to receive at least a part of the smokable material; and
a resistive heater, configured as a pin or blade shape extending along the axial direction of the cavity, and inserted into the smokable material to heat the same when the smokable material is received within the cavity;
wherein the resistive heater is provided with a surface protective layer, the surface protective layer containing a quasicrystal alloy material to reduce adhesion or deposition of organic matter from the smokable material on the surface of the susceptor.

11. The susceptor for an aerosol generation apparatus according to claim 2, wherein the quasicrystal alloy material is a quasicrystal alloy containing aluminum.

12. The susceptor for an aerosol generation apparatus according to claim 11, wherein the quasicrystal alloy material is an Al—Cu—Fe quasicrystal alloy.

13. The susceptor for an aerosol generation apparatus according to claim 2, wherein the quasicrystal alloy material comprises at least one of Al—Fe, Al—Cu—Fe, Al—Cu—Fe—Si, Al—Cu—Fe—Cr, Al—Cu—Fe—Cr—Si, Al—Cu—Co, Al—Cu—Co—Si, Al—Cu—Cr, Al—Co—Ni, Al—Mn, Al—Pd—Mn, Ga—Mn, Bi—Mn, Mg—Zn—Nd or Ti—Zr—Ni quasicrystal alloys.

14. The susceptor for an aerosol generation apparatus according to claim 2, wherein the contact angle of the surface of the protective layer to water is greater than 120 degrees.

15. The susceptor for an aerosol generation apparatus according to claim 2, wherein the contact angle of the surface of the protective layer to aerosol condensation oil is greater than 105 degrees.

16. The susceptor for an aerosol generation apparatus according to claim 2, wherein the protective layer has the microhardness of 5.2-7.0 GPa.
